(19) United States
(12) Patent Application Publication
(10) Pub. No.: US 2024/0406661 A1
(43) Pub. Date: Dec. 5, 2024

(54) Spatial Audio Rendering with Listener Motion Compensation using Metadata

(71) Applicant: Apple Inc., Cupertino, CA (US)

(72) Inventors: Dipanjan Sen, Dublin, CA (US); Francois Becker, Antony (FR); Moo Young Kim, San Diego, CA (US); Sang Uk Ryu, San Diego, CA (US)

(21) Appl. No.: 18/671,744

(22) Filed: May 22, 2024

Related U.S. Application Data
(60) Provisional application No. 63/506,034, filed on Jun. 2, 2023.

(51) Int. Cl. H04S 7/00; G10L 19/008

(52) U.S. Cl. CPC H04S 7/303; G10L 19/008

(57) ABSTRACT

The various aspects of the disclosure here enable a content creation side to control how discrete audio objects that make up a sound program are rendered by a decoding side to achieve high spatial resolution, while giving the content creator the flexibility to decide how complex the spatial audio rendering should be in the decoding side. Metadata associated with the sound program will instruct a spatial audio renderer on how complex its listener motion compensation should be. Other aspects are also described and claimed.

This nonprovisional patent application claims the benefit of the earlier filing date of U.S. provisional application No. 63/506,034 filed Jun. 2, 2023.

### FIELD

An aspect of the disclosure here relates to spatial audio rendering of a sound program by a decoder side process, in accordance with metadata associated with the sound program, where the metadata is provided by a process executing in a content creation side. Other aspects are also described.

### BACKGROUND

A sound program can be produced as a live recording such as a recording of a concert or a sporting event (with or without accompanying video), or it can be previously recorded or previously authored using a software application or software development kit for instance as the soundtrack of a segment of a video game. In all cases, the sound program may be tuned in the content creation side, using digital signal processing, to the taste of a content creator (e.g., a person working as an audio mixer.) The tuned sound program may then be digitally encoded for bitrate reduction before being delivered to a listener's playback device, for instance over the Internet. At the playback device, or elsewhere in a decoding side, the sound program is decoded and then rendered into speaker driver signals that are appropriate to the listener's sound subsystem (e.g., headphones, a surround sound loudspeaker arrangement.)

A sound program may be digitally processed by a spatial audio renderer, so that the resulting speaker driver signals produce a listening experience in which the listener perceives the program closer to how they would hear a scene if they were present in the scene that is being recorded or synthesized. The spatial audio renderer would enable the listener to for example perceive the sound of a bird chirping as coming from a few meters to their right, and another animal rustling through leaves on the ground a few meters to their left, or the sound of the wind blowing against the trees as being all around them.

### SUMMARY

A content creator may decide to craft a sound program so that during spatial audio rendering by a decoding side process, a specified audio object is rendered in accordance with a decoder side detected motion of the listener which may include a head orientation change, a head position change (listener translation), or both. The various aspects of the disclosure here give the content creation side flexibility in specifying the complexity of the listener motion compensation that is performed by a spatial audio renderer in the decoding side, during rendering of a given audio scene component of the sound program. This is achieved through a data structure in metadata associated with the sound program, which instructs a decoding side process to consider a “preferred” degrees of freedom of the listener when rendering the audio object.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the Claims section. Such combinations may have advantages not specifically recited in the above summary.

### BRIEF DESCRIPTION OF THE DRAWINGS

Several aspects of the disclosure here are illustrated by way of example and not by way of limitation in the figures of the accompanying drawings in which like references indicate similar elements. It should be noted that references to “an” or “one” aspect in this disclosure are not necessarily to the same aspect, and they mean at least one. Also, in the interest of conciseness and reducing the total number of figures, a given figure may be used to illustrate the features of more than one aspect of the disclosure, and not all elements in the figure may be required for a given aspect.

FIG. 1 is a block diagram of encoding side and decoding side processes for spatial audio rendering using metadata having a data structure through which the content creator can specify how an audio object is rendered relative to motion of the listener.

FIG. 2 shows several example scenarios that can be encompassed in the various fields of the listener motion compensation related data structure in the metadata.

FIG. 3 describes an example of how the effect of distance attenuation on the sound from a virtual sound source is rendered by the decoding side using metadata.

### DETAILED DESCRIPTION

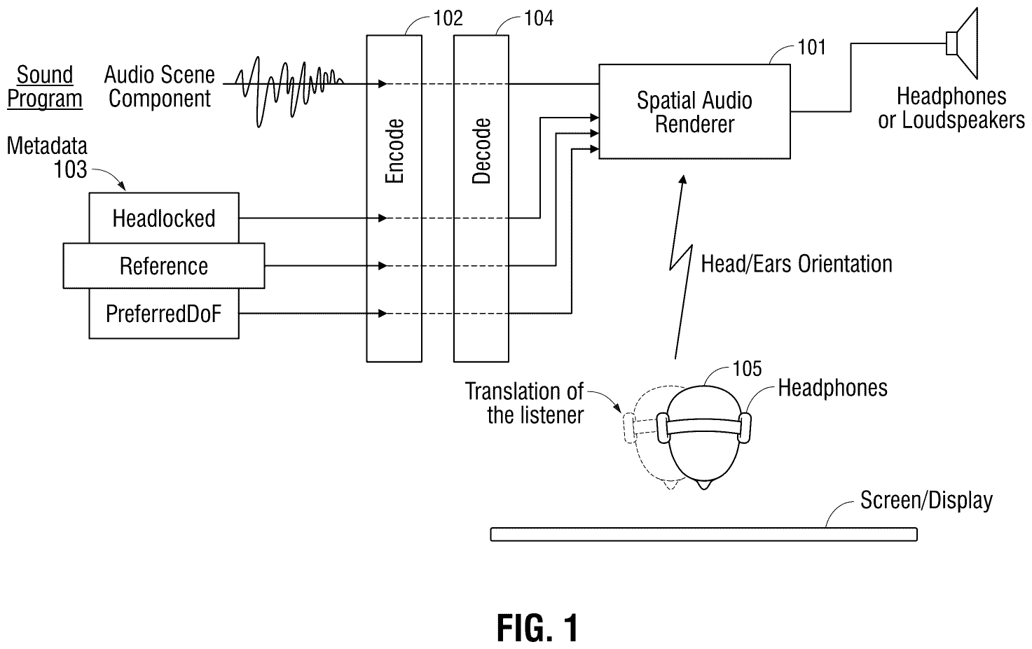

A content creator may want to craft a sound program while also being able to specify how certain audio scene components (ASCs) in the sound program are to be rendered by a spatial audio rendering process in a decoding side. The arrangement in FIG. 1 may achieve such a goal. Referring to FIG. 1, this is a block diagram of example digital processes being executed in an encoding side and in a decoding side for spatial audio rendering using metadata. In the encoding side, metadata 103 is associated with a sound program that has one or more constituent ASCs. The sound program is encoded into a bitstream by an encode process (encode 102), for purposes of bitrate reduction. The metadata 103 may be separately encoded by a process in the encoding side, for bitrate reduction. The metadata may be provided to the decoding side via a separate communication channel, or it may be incorporated into the bitstream along with the encoded sound program.

The sound program is obtained from a content creator (not shown) in the form of one or more constituent audio stems, or one or more constituent ASCs including for example a group of two or more audio objects, where each object is an audio signal, e.g., a pulse code modulated, PCM, audio signal. The sound program may be music as for example the sound of several instruments being played by a band, dialog such as the separate voices of one or more actors in a play or participants of a podcast, a soundtrack of a movie having dialog, music, and effects stems, etc. The sound program may be a live recording (being recorded in real time), e.g., of a sporting event, an on-location news report, etc., a combination of a live recording and synthesized audio signals, or it may be a previously recorded or previously authored music or audio visual work created for example using a software development kit, e.g., a video game or a movie.

The content creator (for example an audio mixer who may be a person having the needed training for mixing audio) decides on how the motion of a listener 105, depicted in the decoding side of FIG. 1 by a human head symbol, will affect spatial audio rendering of a given audio object of the sound program. Information about each ASC, such as a position of the ASC relative to an origin or reference, is inserted into a metadata 103. This origin (also referred to as the sound field origin) may represent a position of the listener 105. The position of the ASC may be given in Cartesian coordinates, or in polar coordinates for example, e.g., distance from the origin, its azimuth angle, and its elevation angle. The motion of the listener 105 may encompass translation, rotation, or both (of their head.) The content creator may then make selections within various fields in the metadata 103, that specify the complexity of the so-called listener motion compensation that will be performed by a spatial audio renderer 101.

In the decoding side, the encoded sound program, and its metadata 103 are provided to or obtained by a playback device, e.g., over the Internet. The playback device may be for instance a digital media player in a console, a smartphone, a tablet computer, etc. One or more decoding side processes are performed by a programmed processor in the playback device (that may have been configured in accordance with instructions stored in a non-transitory machine readable medium such as solid state memory.) One of the decoding side processes (decode 104) serves to undo the encoding, so as to recover the ASCs that make up the sound program and its associated metadata 103. These are then processed by the spatial audio renderer 101 in accordance with instructions in the metadata 103, including compensating for motion of the listener 105 during playback, to produce speaker driver signals suitable for driving the listener's sound subsystem (depicted as a speaker symbol in FIG. 1.)

In one aspect, the spatial audio renderer 101 first converts the decoded one or more ASCs into higher order ambisonics, HOA, format and then converts the HOA format into the speaker driver signals. Alternatively, the decoded one or more ASCs may be converted directly into the channel format of the sound subsystem. The speaker driver signals may be binaural headphone signals, or they may be loudspeaker driver signals for a particular type of surround sound subsystem. This enables the listener 105 to experience the sound program as desired by the content creator, despite the specific type of sound subsystem, with fine granularity or high spatial resolution because each ASC is now rendered in a discrete manner according to instructions associated with that ASC in the metadata.

An example of the data structure in the metadata that relates to or provides instructions for rendering the ASCs (by a rendering engine or the spatial audio renderer 101), by compensating for motion of the listener 105, is as follows.

```
  struct RendererData {
    // ...
    struct HeadphoneVirtualize {
```

| bool mBypass {false} | // true = stereo, false = binaural |
|---|---|
| bool mHasDRR {false} | |
| float mDRR {0.0f} | // Direct to reverberant ratio |

```
    } mHPVirtualize;
    struct Headlock {
```

| bool mHeadlocked | {false} | |
|---|---|---|
| UI3 mReference | {0u}; | // 0: Head, 1: Torso, 2: Screen/Emitter, 3: |

```
Room/Vehicle, 4: World, 5+: reserved
    } mHeadlock;
    struct PreferredDoF {
```

| | |
|---|---|
| UI3 mDoFIndex {0u}; | // 0: 3DoF, 1: 3DoF+, 2: 6DoF, 3+: reserved |

} mPreferredDoF;

| | |
|---|---|
| }; | // per audio scene component, ASC or per ASC group |

The data structure RendererData specifies how a given ASC, or a group of one or more ASCs, are to be rendered, using several substructures, as follows.

An mBypass substructure (also referred to as a field, a message or a variable) indicates the following two alternate possibilities for bypassing a headphone virtualization process of the spatial audio renderer 101, when mBypass=true:
1) the ASC is to be treated by the renderer as a binaural signal (a two channel audio signal that is already in binaural form in that it has embedded therein the head-shape-related transfer functions or HRTFs, such that it should not undergo another pass of HRTF filtering with its inherent timbre coloring and cross-talk); in this case, the left channel is to be applied directly and only to a left headphone speaker, and the right channel is to be applied directly and only to a right headphone speaker; or
2) the ASC is made of one or more audio channels that are to be rendered without the use of HRTF, e.g. for a mixing person who wants to avoid timbre coloring, or avoid cross-talk between left-assigned channel and right-assigned channels on specific ASCs, for example to keep a wide rendering of an ambience effect conveyed by the ASC; note this second option is usually not referred to as “binaural” in the spatial audio field.

When mBypass is not present, or mBypass=false, then the spatial audio renderer 101 assumes that the ASC needs to be input to a headphone virtualization or binaural rendering algorithm (e.g., in the case where the listener's sound subsystem is a pair of headphones.)

The mHasDRR or mDRR substructure, when present, indicates whether the renderer should apply a reverberation effect—as well as its level relative to the direct signal—to the ASC when rendering for headphone listening, e.g., a Direct-to-Reverberant Ratio, DRR. Otherwise, a default tuning parameter is applied by the spatial audio renderer 101.

The mHeadlock substructure, when true or present, indicates whether the renderer should render the ASC as a virtual sound source without compensating for motion of the listener. For instance, when mHeadlock is true or enabled, the virtual sound source will be rendered with the assumption that the listener head position and head orientation are at the origin and remain centered and facing a forward direction of the listener, and they do not change over time. In other words, listener position and orientation tracking are not to be used. For instance, the content creator may wish that a given ASC be locked in this manner, for instance where the ASC is a non-diegetic sound (such as a Foley sound effect, a voice-over narration, or a traditional form of music or score in a motion picture.) At the same time, the content creator may want another ASC to be not locked, perhaps because it is a diegetic sound (e.g., anything that a character in the motion picture can hear.) When not locked (mHeadlock is false or not present), the ASC may be spatially rendered by compensating for a distance change in the listener's position and/or a direction change in the listener's head orientation, relative to a virtual sound source position of the ASC. In other words, the decoding side process is allowed to or may compensate for listener position and orientation. The listener may for example be watching a screen in a room (where the term screen is generically used here to also refer to any electronic display or image emitter such as that of a flat panel television set) and may decide to move around the room. The resulting distance change relative to the television and any head orientation change may be detected using appropriate sensors.

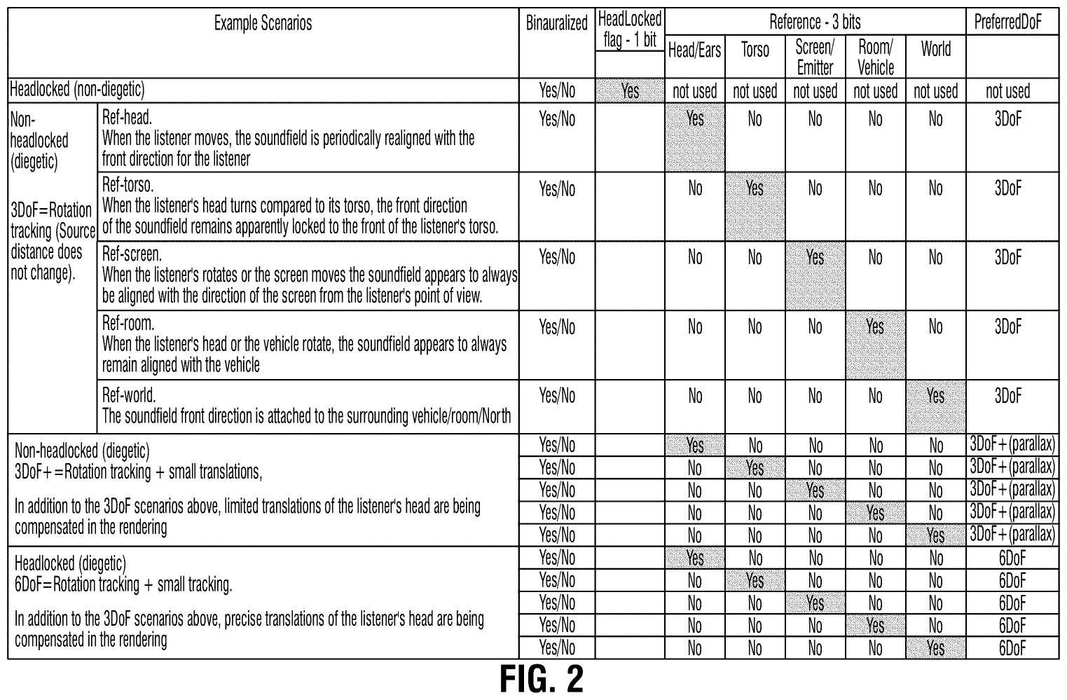

As pointed out above, translation and turning of the head of the listener could be tracked or computed using for example appropriate sensors in the decoding side (e.g., sensors within headphones), and then compensated when rendering the ASC (in the case where mHeadlock is false or absent), to generate various kinds of source positioning and dynamic listening experiences (when the listener is not motionless.) For this purpose, there is a mReference substructure that indicates which referential to use when processing the position and the orientation of a virtual sound source that is represented by a given ASC of the sound program. The mReference may answer the question of where the “front direction” of the sound field is (of which the virtual sound source is a part.) In the case where the content creator sets the flag for mHeadlock (headlocked), mReference will be ignored or not used by the renderer. In the case where the content creator does not set the mHeadlock flag (non headlocked or “not locked”), the renderer is allowed to compensate when spatially rendering the ASC for the motion of the listener. The renderer will in that case use mReference for determining the front direction of the sound field, and for determining how to compensate (when rendering the ASC as the virtual sound source) for the motion of the listener. This is also referred to here as the referential or reference indicated by mReference. The listener's head may be moving and re-orientating inside this referential. FIG. 2 explains this using examples and in more detail.

The table in FIG. 2 shows several example scenarios that can be encompassed in the various substructures of RenderData (in the metadata), to support the concept of tracking or computing the relative position and orientation of both the source and the listener and then compensating for it. This results in various kinds of source positioning and dynamic listening experiences, where the listener is not motionless. For each ASC, the content creator can select a particular row of the table and set the bits for mReference and PreferredDof (preferred degrees of freedom) as indicated in the table. The metadata will be populated accordingly (by the encoding side process.) The decoding side will render the ASC by compensating for motion of the listener, according to the mReference and PreferredDoF settings found in the metadata. Thus, the PreferredDoF defines which of the parameters of the listener's head motions should be considered when compensating the source position and orientation (based on tracking the listener's head motions.) The available scenarios for such rendering of the ASC are as follows:
Not locked with 3DoF (the renderer may compensate for orientation changes in the listener's head, but cannot compensate for any translation of, or changes in the position of, the listener's head);
Not locked with 3DoF+ (the renderer may compensate for orientation changes in the listener's head, and may compensate for a small translation of, or a slight change in the position of, the listener's head, e.g., less than one half of a meter); and
Not Locked with 6DoF (the renderer may compensate for orientation changes in the listener's head, and may compensate for a large translation of, or a substantial change in the position of, the listener's head, e.g., more than one half of a meter.)

For each of the above three scenarios, the content creator also selects within the mReference data substructure any one of the following five reference regimes (depicted in the Reference-3 bits row of the table in FIG. 2.), to be used by the spatial audio renderer 101 when rendering the sound program for playback with compensation for relative movement between a sound source and the listener, on a per ASC basis or a per ASC group (of one or more ASCs) basis:
Head/Ears: the relative orientation between the source and the listener's head could be considered;
Torso: the relative position and orientation between the source and the listener's torso could be considered; this option may be desirable during a music listening scenario;
Screen/Emitter: the relative position and orientation between the screen and the listener could considered for compensating for the source position and orientation, where the screen may be that of a smartphone, a watch, or a television set, on which the video segment of a video game or movie is being presented in real time with its soundtrack; this option may be desirable when the ASC is a message alert or notification sound;
Room/Vehicle: when the ASC is a pilot or driver announcement, a bus tour speech, or a vehicle driving notification, in a vehicle cabin; and
World: relative position and orientation between the source and a world-defined referential (e.g., useful when the ASC is tourism content, or public general information or announcement that needs orientation information (e.g., which direction is North, or information from a Global Positioning System, GPS.)

### Distance Attenuation

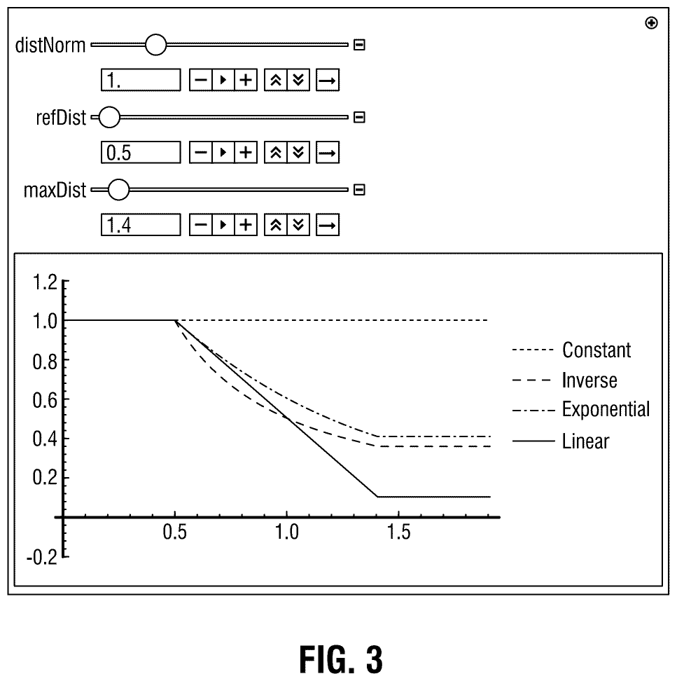

In another aspect, referring now to FIG. 3, the effect of distance attenuation on the sound from a virtual sound source being rendered by the decoding side is controlled in the metadata 103. FIG. 3 illustrates an example graphical user interface at the encoding side, to be used by a content creator or mixer to set three parameters that will control the distance attenuation function. The distance attenuation function may be a gain applied by the spatial audio renderer 101 (to an audio signal of an ASC) that corresponds to the physical decay of sound signal amplitude due to the spreading of the energy from the source in space. This gain is a function of (virtual) distance between the source and listener. Multiple functions, called “attenuation laws”, can be used to provide this gain, corresponding to various artistic or physical realism intents. A variable mAttnLawIndex is defined that points to any one of the following example set of attenuation laws:
0: Constant (default): constAttnlaw(r)=1
1: Inverse: invAttnlaw(r)=min{1, {min{r, mMaxDistance)/refDist)A(−mDistNorm))
2: Exponential: expAttnlaw(r)=min{1, exp(mDistNorm*(mRefDistance−min{r,mMaxDistance))))
3: Linear: linAttnlaw(r)=min(1,max (O, 1−mDistNorm*(min(r,mMaxDistance)−mRefDistance)))

Still referring to FIG. 3, the example user interface shown there refers to the following parameters (in relation to the distance attenuation function) that will populate the metadata 103, according to the position of the slider set by the content creator or mixer:
mDistNorm: a parameter used for tuning some of the attenuation formulas above;
mRefDistance: below this distance, the gain is 1, and attenuation starts beyond this distance;
mMaxDistance: above this distance, the gain is constant;
   FIG. 3 also shows graphically, as four plots or curves overlaid on top of one another, the resulting behavior of the gain curve for each the four different attenuation laws, for a given selection of those parameters.

A further parameter, mAttnNormIndex is defined that indicates which norm to use when computing the distance, e.g., 0 (default): L2 norm is used to compute distance between the listener and the source (iso-gain is a sphere), and 1: Linfinity norm is used to compute the distance between the listener and the source (iso-gain is a cube.)

### Propagation Delay or Doppler Effect Aspects

In another aspect, an encoding side method for spatial audio rendering using metadata comprises encoding an audio scene component (ASC) of a sound program into a bitstream; and providing metadata of the sound program. The metadata comprises a first data structure that instructs a decoding side spatial audio renderer on whether to render the ASC, when rendering the sound program for playback, as a virtual sound source while considering propagation delay, Doppler effect, or both when the virtual sound source is moving relative to a reference position, such as a position of a listener of the playback. In one instance of such a method, the first data structure contains a parameter that can take one of a plurality of values that instruct the spatial audio renderer on how to render an effect of changing distance between the virtual sound source and the reference position, each of the plurality of values refers to a different combination of whether to consider propagation delay and whether to consider Doppler effect. For example, these plurality of values can be at least three values: a first value indicating no propagation delay and no Doppler effect, so that a distance between the virtual sound source and the reference position does not alter a signal delay of the spatial audio renderer rendering the ASC (where this first value may be used when the content creator does not expect any pitch shift, or it may be included as a default value); a second value indicating no propagation delay but with a Doppler effect, so that dynamic variation of the distance is used by a pitch-shifter of the spatial audio renderer to produce pitch alteration for simulating the Doppler effect; and a third value indicating both propagation delay and Doppler effect, so that the distance as well as the dynamic variation of the distance are used by the spatial audio renderer to introduce a delay that can vary, including inherent pitch shifting due to the dynamic variation of the distance. The introduced delay may be implemented as a dynamic delay line in the spatial audio renderer. The metadata may further comprise a second data structure that refers to a speed of sound.

A related decoding side method for spatial audio rendering may proceed as follows. A processor in the decoding side is decoding an ASC of a sound program from a bitstream and is receiving metadata of the sound program. The metadata comprises a first data structure that instructs a decoding side spatial audio renderer on whether to render the ASC, when rendering the sound program for playback, as a virtual sound source while considering propagation delay, Doppler effect, or both when the virtual sound source is moving relative to a reference position such as a position of a listener of the playback. The method may further comprise rendering the ASC as the virtual sound source during the playback, in accordance with the first data structure. Now, the first data structure may comprise a parameter that can take one of a plurality of values that instruct the spatial audio renderer on how to render an effect of changing distance between the virtual sound source and the reference position, each of the plurality of values refers to a different combination of whether to consider propagation delay and whether to consider Doppler effect. There may be at least three of these plurality of values: a first value (as defined above) indicating no propagation delay and no Doppler effect, so that a distance between the virtual sound source and the reference position does not alter a signal delay of the spatial audio renderer rendering the ASC; a second value indicating no propagation delay but with a Doppler effect, so that dynamic variation of the distance is used by a pitch-shifter of the spatial audio renderer to produce pitch alteration for simulating the Doppler effect; and a third value indicating both propagation delay and Doppler effect, so that the distance as well as the dynamic variation of the distance are used by the spatial audio renderer to introduce a delay that can vary, including inherent pitch shifting due to the dynamic variation of the distance.

The following statements may be made in view of the disclosure here.
Statement 1—An encoding side method for spatial audio rendering using metadata, the method comprising: encoding an audio scene component (ASC) of a sound program into a bitstream; and providing metadata of the sound program, wherein the metadata comprises a first data structure that instructs a spatial audio renderer on how to render the ASC, when rendering the sound program for playback, by applying distance attenuation to a sound produced by a virtual sound source as a function of a distance between the virtual sound source and a reference position such as a position of a listener of the playback.
Statement 2—The method of statement 2 wherein the first data structure contains: an attenuation law index that points to one of a plurality of attenuation laws; a parameter used for tuning one of the plurality of attenuation laws; a first threshold below which no distance attenuation is applied to the sound, and above which attenuation is applied to the sound according to the distance; a second threshold above which the distance attenuation is constant; and a norm index that points to one of plurality of approaches for computing the distance.
Statement 3—A decoding side method for spatial audio rendering using metadata, the method comprising: decoding an audio scene component (ASC) of a sound program into a bitstream; and receiving metadata of the sound program, wherein the metadata comprises a first data structure that instructs a spatial audio renderer on how to render the ASC, when rendering the sound program for playback, by applying distance attenuation to a sound produced by a virtual sound source as a function of a distance between the virtual sound source and a reference position such as a position of a listener of the playback.
Statement 4—The method of statement 3 further comprising rendering the ASC as the virtual sound source during the playback, in accordance with the first data structure.
Statement 5—The method of statement 4 or 5 wherein the first data structure contains: an attenuation law index that points to one of a plurality of attenuation laws; a parameter used for tuning one of the plurality of attenuation laws; a first threshold below which no distance attenuation is applied to the sound, and above which attenuation is applied to the sound according to the distance; a second threshold above which the distance attenuation is constant; and a norm index that points to one of plurality of approaches for computing the distance.
Statement 6—An encoding side method for spatial audio rendering using metadata, the method comprising: encoding an audio scene component (ASC) of a sound program into a bitstream; and providing metadata of the sound program, wherein the metadata comprises: a first data structure that instructs a spatial audio renderer on whether to render the ASC, when rendering the sound program for playback, as a virtual sound source while considering propagation delay, Doppler effect, or both when the virtual sound source is moving relative to a reference position, such as a position of a listener of the playback.
Statement 7—The method of statement 6 wherein the first data structure contains a parameter that can take one of a plurality of values that instruct the spatial audio renderer on how to render an effect of changing distance between the virtual sound source and the reference position, each of the plurality of values refers to a different combination of whether to consider propagation delay and whether to consider Doppler effect.
Statement 8—The method of statement 7 wherein the plurality of values are at least three values:
   a first value indicating no propagation delay and no Doppler effect, so that a distance between the virtual sound source and the reference position does not alter a signal delay of the spatial audio renderer rendering the ASC;
   a second value indicating no propagation delay but with a Doppler effect, so that dynamic variation of the distance is used by a pitch-shifter of the spatial audio renderer to produce pitch alteration for simulating the Doppler effect; and
   a third value indicating both propagation delay and Doppler effect, so that the distance as well as the dynamic variation of the distance are used by the spatial audio renderer to introduce a delay that can vary, including inherent pitch shifting due to the dynamic variation of the distance.

Various aspects described herein may be embodied, at least in part, in software. That is, the techniques described above may be carried out in an audio processing system in response to its processor executing instructions contained in a storage medium, such as a non-transitory machine-readable storage medium (e.g., dynamic random access memory, static memory, non-volatile memory). Note the phrase “a processor” is used generically here to refer to one or more processors that may be in separate housings or devices and that may be in communication with each other, for example forming in effect a distributed computing system. Also, in various aspects, hardwired circuitry may be used in combination with software instructions to implement the techniques described herein. Thus, the techniques are not limited to any specific combination of hardware circuitry and software, or to any source for the instructions executed by the audio processing system.

In the description, certain terminology is used to describe features of various aspects. For example, in certain situations, the terms “module”, “processor”, “unit”, “renderer”, “system”, “device”, “filter”, “engine”, “block”, “detector”, “simulation”, “model”, and “component”, are representative of hardware and/or software configured to perform one or more processes or functions. For instance, examples of “hardware” include, but are not limited or restricted to, an integrated circuit such as a processor (e.g., a digital signal processor, microprocessor, application specific integrated circuit, a micro-controller, etc.). Thus, different combinations of hardware and/or software can be implemented to perform the processes or functions described by the above terms, as understood by one skilled in the art. Of course, the hardware may be alternatively implemented as a finite state machine or even combinatorial logic. An example of “software” includes executable code in the form of an application, an applet, a routine or even a series of instructions. As mentioned above, the software may be stored in any type of machine-readable medium.

Some portions of the preceding detailed descriptions have been presented in terms of algorithms and symbolic representations of operations on data bits within a computer memory. These algorithmic descriptions and representations are the ways used by those skilled in the audio processing arts to convey the substance of their work most effectively to others skilled in the art. An algorithm is here, and, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of an audio processing system, or similar electronic device, that manipulates and transforms data represented as physical (electronic) quantities within the system's registers and memories into other data similarly represented as physical quantities within the system memories or registers or other such information storage, transmission or display devices.

The processes and blocks described herein are not limited to the specific examples described and are not limited to the specific orders used as examples herein. Rather, any of the processing blocks may be re-ordered, combined, or removed, performed in parallel or in serial, as desired, to achieve the results set forth above. The processing blocks associated with implementing the audio processing system may be performed by one or more programmable processors executing one or more computer programs stored on a non-transitory computer readable storage medium to perform the functions of the system. All or part of the audio processing system may be implemented as special purpose logic circuitry (e.g., an FPGA (field-programmable gate array) and/or an ASIC (application-specific integrated circuit)). All or part of the audio system may be implemented using electronic hardware circuitry that include electronic devices such as, for example, at least one of a processor, a memory, a programmable logic device or a logic gate. Further, processes can be implemented in any combination of hardware devices and software components.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

While certain aspects have been described and shown in the accompanying drawings, it is to be understood that such aspects are merely illustrative of and not restrictive, and the disclosure is not limited to the specific constructions and arrangements shown and described, since various other modifications may occur to those of ordinary skill in the art.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the claim.

It is well understood that the use of personally identifiable information should follow privacy policies and practices that are recognized as meeting or exceeding industry or governmental requirements for maintaining the privacy of users. Personally identifiable information data should be managed and handled to minimize risks of unintentional or unauthorized access or use, and the nature of authorized use should be clearly indicated to users.

What is claimed is:

1. An article of manufacture comprising:
a non-transitory machine-readable storage medium having stored therein metadata of a sound program, wherein the sound program has an audio scene component, ASC, the metadata comprising:
a first data structure that instructs a spatial audio renderer on whether to render the ASC as a virtual sound source without compensating for motion of a listener of a playback, when rendering the sound program for the playback; and
a second data structure that instructs the spatial audio renderer, when the listener of the playback is not motionless and the first data structure indicates that the ASC may be rendered with compensation for the motion of the listener, as to a reference to use when compensating for the motion of the listener.

2. The article of manufacture of claim 1 wherein the first data structure instructs the spatial audio renderer that it may not compensate for the motion of the listener during the playback when rendering the ASC as the virtual sound source.

3. The article of manufacture of claim 1 wherein the second data structure indicates one of:
the reference is a head of the listener, so that if the listener moves as in a translation or rotation of the head, then the spatial audio renderer re-aligns a front direction of a sound field of the playback as pointing to a current position of the head;
the reference is a torso of the listener, so that if the head turns or translates then the front direction of the sound field remains locked and points to a front of the torso, and a sound field origin is locked to the torso;
the reference is a screen, so that if the head turns or rotates then the front direction of the sound field remains locked and points toward the screen, and the sound field origin is locked to the screen;
the reference is a room or a cabin of a vehicle, so that if the head turns or the vehicle turns, the front direction of the sound field remains aligned with the vehicle, and the sound field origin is locked to the room or the cabin of the vehicle; or
the reference is world-defined, so that the front direction of the sound field remains aligned with a compass-provided direction such as north, and the sound field origin remains locked to a static location on a ground.

4. The article of manufacture of claim 1 wherein the metadata further comprises a third data structure that indicates one of a plurality of capabilities for the spatial audio renderer to compensate for motion of the listener.

5. The article of manufacture of claim 4 wherein the plurality of capabilities for the spatial audio renderer to compensate for motion of the listener, which can be indicated in the third data structure are:
tracking rotation of the head without tracking translation of the head;
tracking translation of the head up to a first threshold distance, and tracking rotation of the head; and
tracking translation of the head greater than the first threshold distance and tracking rotation of the head.

6. The article of manufacture of claim 4 wherein the plurality of capabilities comprises:
a first capability in which the renderer may compensate for orientation changes in a head of the listener, but cannot compensate for any translation of the head of the listener;
a second capability in which the renderer may compensate for orientation changes in the head, and may compensate for a translation of the head that is less than a threshold; and
a third capability in which the renderer may compensate for orientation changes in the head and may compensate for a translation of or a change in a position of the head that is greater than the threshold.

7. A decoding side method for spatial audio rendering using metadata, the method comprising:
decoding an audio scene component (ASC) of a sound program from a bitstream; and
receiving metadata of the sound program, wherein the metadata comprises:
a first data structure that instructs a spatial audio renderer on whether to render the ASC as a virtual sound source without compensating for motion of a listener when rendering the sound program for playback, and
a second data structure that instructs the spatial audio renderer, when a listener of the playback is not motionless and the first data structure indicates that the ASC may be rendered with compensation for the motion of the listener, as to a reference to use when compensating for the motion of the listener.

8. The method of claim 7 wherein the first data structure instructs the spatial audio renderer that it may not compensate for the motion of the listener during the playback when rendering the ASC as the virtual sound source.

9. The method of claim 7 wherein the second data structure indicates one of:
the reference is a head of the listener, so that if the listener moves as in a translation or rotation of the head, then the spatial audio renderer re-aligns a front direction of a sound field of the playback as pointing to a current position of the head;
the reference is a torso of the listener, so that if the head turns or translates then the front direction of the sound field remains locked and points to a front of the torso, and a sound field origin is locked to the torso;
the reference is a screen, so that if the head turns or rotates then the front direction of the sound field remains locked and points toward the screen, and the sound field origin is locked to the screen;
the reference is a room or a cabin of a vehicle, so that if the head turns or the vehicle turns, the front direction of the sound field remains aligned with the vehicle, and the sound field origin is locked to the room or the cabin of the vehicle; or
the reference is world-defined, so that the front direction of the sound field remains aligned with a compass-provided direction such as north, and the sound field origin remains locked to a static location on a ground.

10. The method of claim 7 wherein the metadata further comprises a third data structure that indicates one of a plurality of capabilities for the spatial audio renderer to compensate for motion of the listener.

11. The method of claim 10 wherein the plurality of capabilities for the spatial audio renderer to compensate for motion of the listener, which can be indicated in the third data structure are:
tracking rotation of the head without tracking translation of the head;
translation of the head up to a first threshold distance, and tracking rotation of the head; and
tracking translation of the head greater than the first threshold distance, and tracking rotation of the head.

12. The method of claim 10 wherein the plurality of capabilities comprises:
a first capability in which the renderer may compensate for orientation changes in a head of the listener, but cannot compensate for any translation of the head of the listener;
a second capability in which the renderer may compensate for orientation changes in the head of the listener, and may compensate for a translation of the head that is less than a threshold; and
a third capability in which the renderer may compensate for orientation changes in the head and may compensate for a translation of or a change in a position of the head that is greater than the threshold.

13. A decoding side method for spatial audio rendering using metadata, the method comprising:
decoding an audio scene component (ASC) of a sound program from a bitstream; and
receiving metadata of the sound program, wherein the metadata comprises:
a first data structure that instructs a spatial audio renderer on whether to render the ASC as a virtual sound source while considering propagation delay, Doppler, or both, when the spatial audio renderer is rendering the sound program for playback and the virtual sound source is moving relative to a reference position such as a position of a listener of the playback.

14. The method of claim 13 further comprising:
rendering the ASC as the virtual sound source during the playback, in accordance with the first data structure.

15. The method of claim 14 wherein the first data structure comprises a parameter that can take one of a plurality of values that instruct the spatial audio renderer on how to render an effect of changing distance between the virtual sound source and the reference position, each of the plurality of values refers to a different combination of whether to consider propagation delay and whether to consider Doppler effect.

16. The method of claim 15 wherein the plurality of values are at least three values:
a first value indicating no propagation delay and no Doppler effect, so that a distance between the virtual sound source and the reference position does not alter a signal delay of the spatial audio renderer rendering the ASC;
a second value indicating no propagation delay but with a Doppler effect, so that dynamic variation of the distance is used by a pitch-shifter of the spatial audio renderer to produce pitch alteration for simulating the Doppler effect; and
a third value indicating both propagation delay and Doppler effect, so that the distance as well as the dynamic variation of the distance are used by the spatial audio renderer to introduce a delay that can vary, including inherent pitch shifting due to the dynamic variation of the distance.

17. The method of claim 16 wherein the delay is introduced by a dynamic delay line in the spatial audio renderer.

18. The method of claim 17 wherein the first value is a default value.

19. The method of claim 13 wherein the metadata comprises a second data structure that refers to a speed of sound.

20. The method of claim 13 wherein the first data structure comprises a parameter that can take one of a plurality of values that instruct the spatial audio renderer on how to render an effect of changing distance between the virtual sound source and the reference position, each of the plurality of values refers to a different combination of whether to consider propagation delay and whether to consider Doppler effect.
